(19) United States
(12) Patent Application Publication
(10) Pub. No.: US 2025/0236276 A1
(43) Pub. Date: Jul. 24, 2025

(54) HOUSING FOR A PISTON-CYLINDER DEVICE AND PISTON-CYLINDER DEVICE FOR A VEHICLE BRAKE SYSTEM

(71) Applicant: Robert Bosch GmbH, Stuttgart (DE)

(72) Inventor: Richard Haug, Altdorf (DE)

(21) Appl. No.: 18/855,446

(22) PCT Filed: Jun. 2, 2023
(86) PCT No.: PCT/EP2023/064866

§ 371 Date: Oct. 9, 2024

(30) Foreign Application Priority Data
Jun. 8, 2022 (DE) 10 2022 205 828.3

(51) Int. Cl. B60T 13/74; B60T 13/16

(52) U.S. Cl. CPC B60T 13/745; B60T 13/161

(57) ABSTRACT

A housing for a piston-cylinder device of a vehicle brake system. The housing has at least one pressure compensation groove structured into at least one inner surface of the housing. The groove extends in each case starting at least from the pre-chamber and up to at least the first chamber in such a way that, during the adjusting movement of the first piston component oriented in the direction away from the pre-chamber toward the first chamber, at least one gaseous and/or liquid medium present in the first chamber can be transferred out of the first chamber through the at least one pressure compensation groove into the pre-chamber. A piston-cylinder device for a vehicle brake system is also described having at least one pressure compensation path.

### FIELD

The present invention relates to a housing for a piston-cylinder device of a vehicle brake system and to a piston-cylinder device for a vehicle brake system. The present invention also relates to a production method for a housing for a piston-cylinder device of a vehicle brake system and to a production method for a piston-cylinder device for a vehicle brake system.

### BACKGROUND INFORMATION

German Patent Application No. DE 10 2015 217 522 A1 describes a piston-cylinder device for a vehicle brake system in which a valve body is arranged so as to be adjustable between a pre-chamber of the piston-cylinder device and a further chamber of the piston-cylinder device in such a way that the valve body is adjustable away from the pre-chamber and at least partially into the further chamber by means of a motor force of an electric motor transmitted to the valve body via a spindle drive, and the motor force can be transmitted to the primary piston by means of the adjusted valve body via a mechanical contact of at least one force-transmission component, contacted by the valve body, with a primary piston of a brake master cylinder.

### SUMMARY

The present invention provides a housing for a piston-cylinder device of a vehicle brake system, a piston-cylinder device for a vehicle brake system, a production method for a housing for a piston-cylinder device of a vehicle brake system, and a production method for a piston-cylinder device for a vehicle brake system.

The present invention provides housings for piston-cylinder devices and piston-cylinder devices which, due to their at least one pressure compensation groove or their at least one pressure compensation path, even in the event of a rapid adjusting movement of their first piston component in the direction away from the pre-chamber toward the first chamber still allow pressure compensation between the first chamber and the pre-chamber. An undesired negative pressure in the pre-chamber, which would counteract the desired rapid adjusting movement of the first piston component away from the pre-chamber to the first chamber, is thus reliably prevented. This contributes to increasing the efficiency of the relevant piston-cylinder device during the braking of a vehicle equipped therewith. The present invention described here thus improves a driving comfort and a safety standard of a vehicle using the present invention. As will be explained in more detail below, the present invention also reduces the risk of air being introduced into a brake circuit hydraulically connected to the relevant piston-cylinder device, a risk of dirt being sucked into the vehicle brake system equipped with the relevant piston-cylinder device, and a risk of damage to a sealing element of the relevant piston-cylinder device, to a pressure compensation element of the relevant piston-cylinder device, to a microcontroller of the relevant piston-cylinder device and/or to a seal of the microcontroller.

In an advantageous embodiment of the housing for a piston-cylinder device according to the present invention, the at least one pressure compensation groove is structured into the at least one inner surface of the housing by means of an extrusion process. The at least one pressure compensation groove can thus be integrated into the housing “directly”/during housing production, without this being associated with a (significant) additional work effort during housing production. The formation of the at least one pressure compensation groove on the housing thus does not contribute/hardly contributes to an increase in the production costs thereof.

As an advantageous development of the present invention, the first piston component can have at least one guide part which projects in each case into at least one guide groove structured into the at least one inner surface of the housing, which groove extends in each case starting at least from the pre-chamber and up to at least the first chamber, wherein the at least one pressure compensation groove is structured in each case as a tapering of the at least one guide groove into the at least one inner surface of the housing. The at least one pressure compensation groove can thus be formed in a working step shared with the formation of the at least one guide groove, so that the additional effort for work to be carried out in order to form the at least one pressure compensation groove is negligible.

The housing according to the present invention can be, for example, a brake master cylinder housing or a housing of a motorized brake pressure buildup device which can be or is integrated into a hydraulic system of the vehicle brake system. The present invention described here can thus be used in a variety of ways. However, it is pointed out here that the possible uses described here for the housing are to be interpreted only by way of example.

Also in an advantageous embodiment of the piston-cylinder device according to the present invention, the piston-cylinder device is a brake master cylinder or a motorized brake pressure buildup device that can be or is integrated into a hydraulic system of the vehicle brake system. A piston-cylinder device according to the present invention, which instead of at least one pressure compensation groove comprises the at least one pressure compensation path, can thus also be used in a variety of ways. However, in this case too, the possibilities of use listed here for the piston-cylinder device are to be interpreted only by way of example.

The preceding advantages are also ensured if a corresponding production method for a housing for a piston-cylinder device of a vehicle brake system or a production method for a piston-cylinder device for a vehicle brake system is carried out. It is expressly pointed out that the production methods mentioned here can also be further developed according to the above-explained embodiments of the housing or of the piston-cylinder device according to the present invention.

### BRIEF DESCRIPTION OF THE DRAWINGS

Further features and advantages of the present invention will be explained in the following with reference to the figures.

FIG. 1A to 1F show schematic full and partial representations of an example embodiment of a piston-cylinder device, or of its housing, according to the present invention.

FIG. 2 shows a flowchart to explain an example embodiment of the production method for a housing for a piston-cylinder device of a vehicle brake system, according to the present invention.

FIG. 3 shows a flowchart to explain an example embodiment of the production method for a piston-cylinder device for a vehicle brake system, according to the present invention.

### DETAILED DESCRIPTION OF EXAMPLE EMBODIMENTS

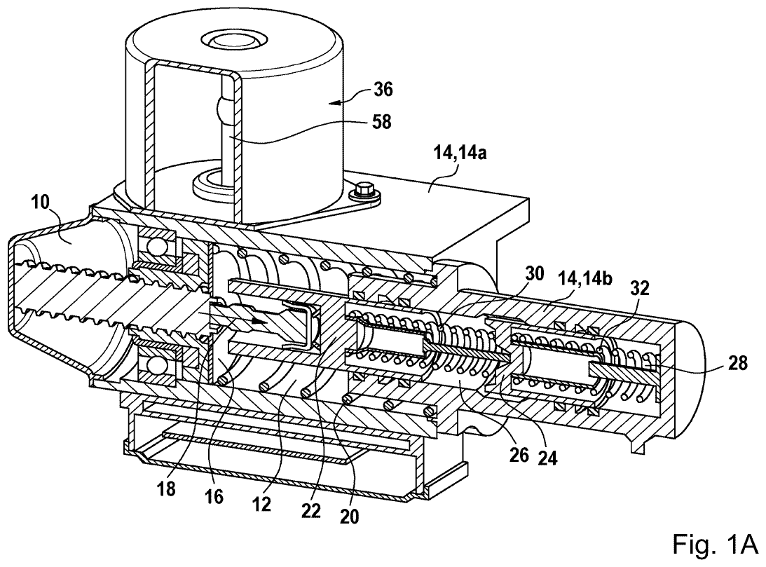

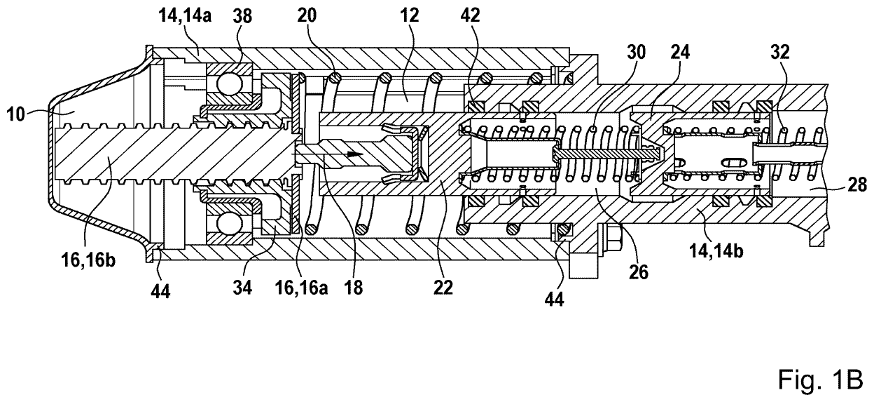

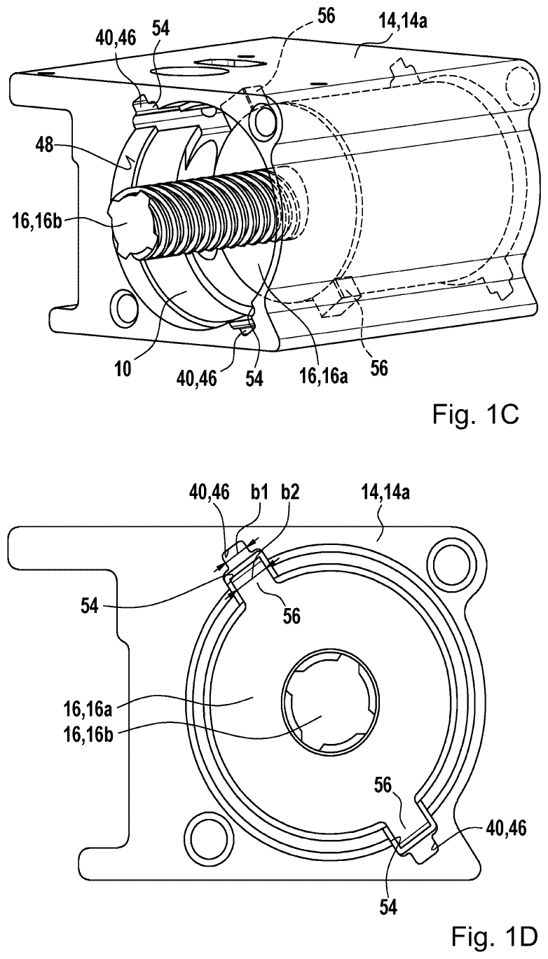

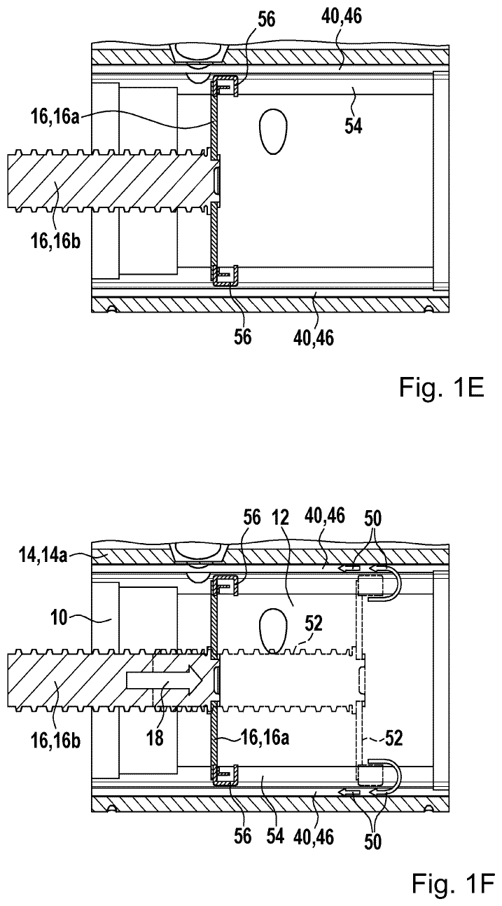

FIGS. 1A to 1F show schematic full and partial representations of an embodiment of a piston-cylinder device, or of its housing.

The piston-cylinder device schematically shown in FIGS. 1A to 1F can be used for a vehicle brake system. It is expressly pointed out that a usability of the piston-cylinder device described below is not limited to a specific type of vehicle brake system. Also, a vehicle/motor vehicle equipped with the vehicle brake system is not limited to a specific vehicle type/motor vehicle type.

The piston-cylinder device has at least one pre-chamber 10 formed on and/or in the piston-cylinder device and a first chamber 12 formed in the piston-cylinder device. Preferably, the pre-chamber 10 is formed on and/or in a housing 14 of the piston-cylinder device and the first chamber 12 is formed in the housing 14. In addition, the piston-cylinder device has a first piston component 16 which is arranged between the pre-chamber 10 and the first chamber 12 in such a way that the first chamber 12 is located on a first side of the first piston component 16, while the pre-chamber 10 is present on a second side of the first piston component 16 directed away from the first side. In addition, the first piston component 16 is arranged to be adjustable in the piston-cylinder device in such a way that the first piston component 16 can be displaced into an adjusting movement in the direction away from the pre-chamber 10 toward the first chamber 12, wherein a volume of the first chamber 12 can be/is reduced by means of the adjusting movement of the first piston component 16. Furthermore, the direction oriented from the pre-chamber 10 to the first chamber 12 is referred to as a braking direction 18 of the first piston component 16.

The first piston component 16 can be supported, for example, by means of a first return spring 20 present in the first chamber 12 in such a way that a restoring force of the first return spring 20 counteracts the initiatable adjusting movement of the first piston component 16 in its braking direction 18. Advantageous possibilities for initiating the adjusting movement of the first piston component 18, which movement is oriented in the braking direction 16, will be discussed below.

As can also be seen in FIG. 1A, the piston-cylinder device is also equipped with a second piston component 22 and possibly also with a third piston component 24 in addition to the first piston component 16. The second piston component 22 is arranged adjustably between the first chamber 12 and a second chamber 26. Correspondingly, if the third piston component 24 is present in the piston-cylinder device, the third piston component 24 can also be arranged adjustably between the second chamber 26 and a third chamber 28. The second piston component 22 can in particular be a rod piston 22, while the third piston component 24 can be designed as a floating piston 24. The rod piston 22 can be supported on the floating piston 24 by means of a second return spring 30 or, if the piston-cylinder device has no floating piston 24, on an inner wall of the housing 14. If present, the floating piston 24 can be supported on an inner wall of the housing 14 by means of a third return spring 32.

As can be seen in FIG. 1B, the first piston component 16, which is displaced into the adjusting movement in its braking direction 18, can be brought into mechanical contact with the second piston component 22, so that the at least one force initiating the adjusting movement of the first piston component 16 is/can be transmitted to the second piston component 22 via the mechanical contact of the first piston component 16 with the second piston component 22. Alternatively, at least one compact force transmission component arranged between the first piston component 16 and the second piston component 22 is/can be co-adjusted together with the first piston component 16 displaced into the adjusting movement in its braking direction 18 such that the at least one force initiating the adjusting movement of the first piston component 16 can be/is transmitted to the second piston component 22 via a mechanical contact between the first piston component 16, the at least one force transmission component and the second piston component 22. It is expressly pointed out that the at least one compact force transmission component is not to be understood to mean a liquid substance or a gaseous substance. The force transmission between the first piston component 16 and the second piston component 22 thus (essentially) does not take place via a pressure increase.

By way of example, in the embodiment described here, the first piston component 16 comprises a sliding plate 16a with a spindle 16b fastened thereto (see FIG. 1B). However, a designability of the first piston component 16 is not limited to the components 16a and 16b. Specifically, in the embodiment described here, the spindle 16b of the first piston component 16 is in operative engagement with a spindle nut 34 which converts a rotational movement of an electric motor 36 into the translational adjusting movement of the first piston component 16. For this purpose, the spindle nut 34 is held in the housing 14 of the piston-cylinder device by means of a bearing 38, such as specifically a ball bearing 38. The spindle nut 34 and the bearing 38 are typical examples of components of a piston-cylinder device which block a transfer of a gaseous and/or liquid medium present in the first chamber 12 out of the first chamber 12 into the pre-chamber 10, in particular in the event of a relatively rapid adjusting movement of the first piston component 16 in the braking direction 18, whereby conventionally a desired pressure equalization between the pre-chamber 10 and the first chamber 12 is delayed or prevented. This conventionally leads to the occurrence of an undesired negative pressure in the pre-chamber 10 during operation of a device according to the related art, as a result of which a counterpressure can be triggered for the desired rapid adjusting movement of the first piston component 16 in the braking direction 18.

In order to eliminate the above-explained conventional disadvantage of a device according to the related art, the piston-cylinder device described here comprises at least one pressure compensation path 40 (see FIGS. 1C to 1F), which is formed on and/or in the piston-cylinder device in such a way that, during the adjusting movement of the first piston component 16, which movement is oriented in the braking direction 18, at least one gaseous and/or liquid medium present in the first chamber 12 can be/is transferred out of the first chamber 12 through the at least one pressure compensation path 40 into the pre-chamber 10. The at least one pressure compensation path 40 thus prevents an undesired compression of the at least one gaseous and/or liquid medium present in the first chamber 12 even in the event of a relatively rapid adjusting movement of the first piston component 16 in the braking direction 18 and at the same time prevents an undesired negative pressure in the pre-chamber 10. Even if grease is present on the first piston component 16, the at least one pressure compensation path 40 ensures the advantageous transfer of the at least one medium out of the first chamber 12 into the pre-chamber 10 during the rapid adjusting movement of the first piston component 16 in the braking direction 18. The desired relatively rapid adjusting movement of the first piston component 16 in the braking direction 18 is therefore not/hardly prevented by a counterpressure, so that the piston-cylinder device described here can, due to its at least one pressure compensation path 40, (co-)effect even highly dynamic braking of the vehicle/motor vehicle equipped with the relevant vehicle brake system. The formation of the at least one pressure compensation path 40 on and/or in the piston-cylinder device thus improves an efficiency of the piston-cylinder device, which contributes to increasing driving comfort and a safety standard of the vehicle/motor vehicle equipped therewith.

The at least one pressure compensation path 40 is preferably in each case a valve-free pressure compensation path 40. This eliminates the need to “release” the at least one pressure compensation path 40 in order to trigger the advantageous transfer of the at least one medium out of the first chamber 12 into the pre-chamber 10.

The formation of the at least one pressure compensation path 40 on and/or in the piston-cylinder device also allows the piston-cylinder device to be operated in a gentler manner which is more resistant to wear. Because the at least one pressure compensation path 40, in particular in the event of a relatively rapid adjusting movement of the first piston component 16 in the braking direction 18, prevents an undesired compression of the at least one medium present in the first chamber 12, the conventional risk of a pressure application to at least one seal 42 guiding the second piston component 22 is also significantly reduced by means of the at least one pressure compensation path 40. A sealing lip of the at least one seal 42 is thus better protected during operation of the piston-cylinder device. This also reduces a conventional risk of an air input in at least one hydraulic brake circuit (not shown) connected to the piston-cylinder device. At least one housing seal 44 of the housing 14 of the piston-cylinder device is also better protected against damage due to the frequency pressure peaks occurring, which is reduced by means of the at least one pressure compensation path 40 (to a frequency of nearly zero), during operation of the piston-cylinder device. Likewise, further components of the piston-cylinder device, or of the vehicle brake system interacting therewith, such as a microcontroller (ECU, electronic control unit), especially at least one seal of the microcontroller and/or a pressure compensation element (DAE), are better protected from damage by pressure application by means of the formation of the at least one pressure compensation path 40. The at least one pressure compensation path 40 also counteracts an undesired suction of moisture into the piston-cylinder device from its surroundings.

As can be seen in FIGS. 1C to 1F, the at least one pressure compensation path 40 can in particular be structured as at least one pressure compensation groove 46 into at least one inner surface 48 of the housing 14. The at least one inner surface 48 of the housing 14 can in particular be understood to mean a surface on which the first piston component 16 can be or is adjustably arranged in such a way that the first piston component 16 slides along the at least one inner surface 48 during its adjusting movement in the braking direction 18. By means of a formation of the at least one pressure compensation groove 46 such that the at least one pressure compensation groove 46 extends in each case starting at least from the pre-chamber 10 and up to at least the first chamber 12, it can be ensured that, during the adjusting movement of the first piston component 16, which movement is oriented in the braking direction 18, the at least one medium present in the first chamber 12 can be/is transferred out of the first chamber 12 through the at least one pressure compensation groove 46 into the pre-chamber 10. As can be seen from a comparison of FIGS. 1B and 1C, in this case neither the spindle nut 34 nor the bearing 38 or any grease possibly present counteract the desired transfer of the at least one gaseous and/or liquid medium. As shown in FIG. 1F by means of the arrows 50 and the dashed line 52, the at least one medium present in the first chamber 12, such as air, can escape from the first chamber 12 into the pre-chamber 10 via the at least one pressure compensation groove 46 during the adjusting movement of the first piston component 16 in the braking direction 18. This prevents an undesired negative pressure in the pre-chamber 10 or an undesired compression of the medium in the first chamber 12. The at least one pressure compensation groove 46 thus makes possible a sufficiently early negative pressure compensation even in the event of a relatively rapid adjusting movement of the first piston component 16 in the braking direction 18.

The at least one pressure compensation groove 46 structured into the at least one inner surface 48 of the housing 14 offers a cost-effective possibility for realizing a negative pressure compensation, in particular over a full housing length of the housing. As can be seen from FIGS. 1A to 1F, a basic functionality of the piston-cylinder device remains unchanged by the formation of the at least one pressure compensation groove 46 for negative pressure compensation. The at least one pressure compensation groove 46 thus brings about an increase in the efficiency of the piston-cylinder device without its operability being impaired thereby.

Preferably, the at least one pressure compensation groove 46 is structured by means of an extrusion process into the at least one inner surface 48 of the housing 14. This makes possible a cost-effective formation of the at least one pressure compensation groove 46 on the housing 14, which is integrated into the production of the housing 14. As can be seen in FIGS. 1A and 1B, the at least one pressure compensation groove 46 can also be formed on a housing part 14a which is assembled with at least one further housing part 14b to form the housing 14 of the piston-cylinder device. The housing 14 or the housing part 14a can be manufactured in its basic form (internal and external form), for example, by an aluminum rod pressing method. The at least one pressure compensation groove 46 can then be structured by means of an extrusion process into the at least one inner surface 48 of the housing 14/housing part 14a, as a result of which the at least one pressure compensation groove is integrated directly in the housing cross-section of the housing 14/housing part 14a. It is not necessary to equip the housing 14 with an additional housing component in order to realize the at least one pressure compensation groove 46. No further manufacturing steps or components are thus necessary in order to form the at least one pressure compensation groove 46 on the subsequent piston-cylinder device.

Since no further component is necessary to form the at least one pressure compensation groove 46, the formation of the at least one pressure compensation groove 46 increases neither a component diversity of the piston-cylinder device nor its assembly effort. However, the formation of the at least one pressure compensation groove 46 causes an increase in the packing density of the piston-cylinder device and serves to secure the competitiveness thereof.

In addition, the at least one pressure compensation groove 46 can be formed on the housing 14 together with/simultaneously with the formation of at least one guide groove 54 for guiding at least one guide part 56 of the first piston component 16. The first piston component 16 frequently comprises the at least one guide part 56 in order to prevent an undesired rotational movement of the first piston component 16 even in the case of a rapid adjusting movement of the first piston component 16. The at least one guide part 56 of the first piston component 16 can in particular take the form of a slider 56. The at least one guide part 56 of the first piston component 16 and the at least one guide groove 54 interacting therewith can also be referred to as an anti-rotation device of the first piston component 16. The first piston component 16 is generally guided via the at least one guide groove 54 into which the at least one guide part 56 projects in each case. The at least one guide groove 54 can in each case be structured into the at least one inner surface 48 of the housing 14 in such a way that it in each case extends starting at least from the pre-chamber 10 and up to at least the first chamber 12. A shared/simultaneous formation of the at least one guide groove 54 and of the at least one pressure compensation groove 46 is possible in this case in a cost-effective manner, in that the at least one pressure compensation groove 46 is structured in each case as a tapering of the at least one guide groove 54 into the at least one inner surface 48 of the housing 14. The formation of the at least one pressure compensation groove 46 as a tapering of the at least one guide groove 54 can be understood to mean that the at least one pressure compensation groove 46 is structured into the housing 14 on a side of the adjacent guide groove 54 in each case directed away from the first piston component 16, wherein a first trench width b1 of the relevant pressure compensation groove 46 is smaller than a second trench width b2 of the adjacent guide groove 54 (see FIG. 1D).

However, it is pointed out that it is merely optional for the at least one pressure compensation path 40 to be formed as in each case the at least one pressure compensation groove. The advantages described above are also ensured, for example, when the at least one pressure compensation path 40 runs through at least a component of the piston-cylinder device other than its housing 14. The at least one pressure compensation path 40 running through at least a component of the piston-cylinder device other than the housing 14 also makes possible effective pressure compensation and can generally be implemented cost-effectively during the manufacture of the piston-cylinder device. For example, the at least one pressure compensation path 40 can also be understood to mean at least one pressure compensation path running through the first piston component 16. Such a pressure compensation path 40 also advantageously contributes to rapid pressure compensation between the pre-chamber 10 and the first chamber 12 of the piston-cylinder device, in particular in the event of dynamic operation of the piston-cylinder device.

In the embodiment of FIGS. 1A to 1F, the piston-cylinder device is, for example, a brake master cylinder, specifically a brake master cylinder of a brake-by-wire brake system. The housing 14 of the piston-cylinder device can therefore be referred to as a brake master cylinder housing. However, it is expressly pointed out that the embodiment of the brake master cylinder shown schematically in FIG. 1A is to be understood only by way of example specifically for a brake-by-wire brake system. The formation of the first piston component 16 with its spindle 16b, the conversion of the rotational movement of the electric motor 36 into the translational adjusting movement of the first piston component 16 by means of the spindle nut 34, and also the connection of the electric motor 36 to the spindle nut 34 via a worm shaft 58, shown schematically in FIG. 1A, are also to be interpreted only by way of example.

In an alternative embodiment, the first piston component 16 can also be a valve body (boost body) of an electromechanical/motorized brake booster of the piston-cylinder device, which valve body is upstream of a brake master cylinder of the piston-cylinder device with a brake actuation element connected thereto, such as specifically a brake pedal. Likewise, the first piston component 16 can also be understood to mean a driver braking force transmission component on which only a driver braking force exerted on the brake actuation element/brake pedal can be transmitted but no motor force of an electric motor. The piston-cylinder device can thus also be a “brake-boosterless” brake master cylinder.

Alternatively, the piston-cylinder device can also be a motorized brake pressure buildup device that can be or is integrated into a hydraulic system of the vehicle brake system.

In this case, the housing of the piston-cylinder device can be referred to as a housing 14 of the motorized brake pressure buildup device that can be or is integrated into the hydraulic system of the vehicle brake system. The at least one force initiating the adjusting movement of the first piston component 16 in the braking direction 18 can thus be the motor force of the electric motor 36 of the piston-cylinder device and/or the driver braking force exerted on the brake actuation element/brake pedal.

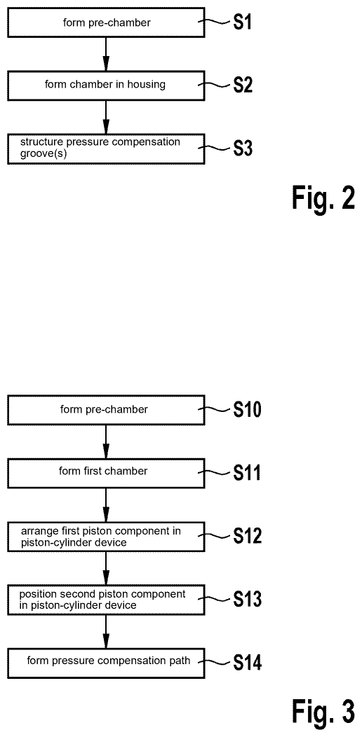

FIG. 2 shows a flowchart for explaining an embodiment of the production method for a housing for a piston-cylinder device of a vehicle brake system.

By means of the production method described below, for example, the housing 14 or the housing part 14a of the piston-cylinder device explained above can be produced. However, an executability of the production method is not limited thereto.

In a method step S1, a pre-chamber is formed on and/or in the (subsequent) housing. In addition, in a method step S2, a first chamber is formed in the (subsequent) housing. The method steps S1 and S2 can be carried out in any order, overlapping in time or simultaneously. Here, the pre-chamber and the first chamber are arranged relative to one another in such a way that a first piston component can be adjustably arranged on and/or in the housing in such a way that the first chamber is located on a first side of the first piston component and the pre-chamber is formed on a second side of the first piston component directed away from the first side. In addition, when the method steps S1 and S2 are carried out, an adjustability of the first piston component is ensured in such a way that a volume of the first chamber can be/is reduced by means of an adjusting movement of the first piston component oriented in the direction away from the pre-chamber toward the first chamber. Furthermore, at least one second piston component can also be arranged adjustably in the housing in such a way that at least one force initiating the adjusting movement oriented in the direction away from the pre-chamber toward the first chamber can be transmitted to the second piston component via a mechanical contact of the first piston component with the second piston component or a mechanical contact between the first piston component, of at least one compact force transmission component arranged between the first piston component and the second piston component, and the second piston component.

The production method described here also comprises a method step S3 in which at least one pressure compensation groove, which extends in each case starting at least from the pre-chamber and up to at least the first chamber, is structured into at least one inner surface of the housing in such a way that, during the adjusting movement of the first piston component, which movement is oriented in the direction away from the pre-chamber toward the first chamber, at least one gaseous and/or liquid medium present in the first chamber can be/is transferred out of the first chamber through the at least one pressure compensation groove into the pre-chamber. The at least one pressure compensation groove can in particular be structured by means of an extrusion process into the at least one inner surface of the housing, whereby the method step S3 can advantageously be carried out simultaneously with the method steps S1 and S2. Preferably, in method step S3, at least one guide groove, which extends in each case starting at least from the pre-chamber and up to at least the first chamber, is structured into the at least one inner surface of the housing, also for at least one guide part of the first piston component. This is done in such a way that, after the first piston component has been arranged, the at least one guide part of the first piston component projects in each case into the at least one guide groove. In this case, the at least one pressure compensation groove is preferably structured in each case as a tapering of the at least one guide groove into the at least one inner surface of the housing.

FIG. 3 shows a flowchart for explaining an embodiment of the production method for a piston-cylinder device for a vehicle brake system.

The production method described here is advantageously suitable for producing the piston-cylinder device explained above, but is not limited to such an embodiment.

In a method step S10, a pre-chamber is formed on and/or in the piston-cylinder device. In addition, in a method step S11, a first chamber is formed in the piston-cylinder device. As method step S12, a first piston component is then arranged adjustably on and/or in the piston-cylinder device in such a way that the first chamber is located on a first side of the first piston component and the pre-chamber is present on a second side of the first piston component directed away from the first side, while a volume of the first chamber is reduced by means of an adjusting movement of the first piston component, which movement is oriented in the direction away from the pre-chamber toward the first chamber. In addition, in a method step S13, at least one second piston component is positioned adjustably in the piston-cylinder device in such a way that at least one force initiating the adjusting movement oriented in the direction away from the pre-chamber toward the first chamber is transmitted to the second piston component via a mechanical contact of the first piston component with the second piston component or a mechanical contact between the first piston component, of at least one compact force-transmission component arranged between the first piston component and the second piston component, and the second piston component.

The production method additionally comprises a method step S14 in which at least one pressure compensation path on and/or in the piston-cylinder device is formed such that, during the adjusting movement of the first piston component, which movement is oriented in the direction away from the pre-chamber toward the first chamber, at least one gaseous and/or liquid medium present in the first chamber is transferred out of the first chamber through the at least one pressure compensation path into the pre-chamber. The piston-cylinder device produced by means of the production method described here thus fulfills the advantages already explained above. Method steps S10 to S14 can be performed in any order, possibly simultaneously or overlapping in time.

1-10. (canceled)

11. A housing for a piston-cylinder device of a vehicle brake system, comprising:
a pre-chamber formed on and/or in the housing; and
a first chamber formed in the housing;
wherein a first piston component can be or is adjustably arranged on and/or in the housing in such a way that the first chamber is located on a first side of the first piston component, the pre-chamber is located on a second side of the first piston component directed away from the first side, and a volume of the first chamber can be reduced by an adjusting movement of the first piston component, the adjusting movement being oriented in a direction away from the pre-chamber toward the first chamber,
wherein at least one second piston component can be or is arranged adjustably in the housing in such a way that at least one force initiating the adjusting movement oriented in the direction away from the pre-chamber toward the first chamber can be transmitted to the second piston component via a mechanical contact of the first piston component with the second piston component or a mechanical contact between the first piston component, of at least one compact force transmission component arranged between the first piston component and the second piston component, and the second piston component, and
wherein at least one pressure compensation groove is structured into at least one inner surface of the housing, the at least one groove extending in each case starting at least from the pre-chamber and up to at least the first chamber in such a way that, during the adjusting movement of the first piston component, the adjusting movement being oriented in the direction away from the pre-chamber toward the first chamber, at least one gaseous and/or liquid medium present in the first chamber can be transferred out of the first chamber through the at least one pressure compensation groove into the pre-chamber.

12. The housing according to claim 11, wherein the at least one pressure compensation groove is structured by an extrusion process into the at least one inner surface of the housing.

13. The housing according to claim 11, wherein the first piston component has at least one guide part which projects in each case into at least one guide groove structured into the at least one inner surface of the housing, each at least one guide groove extending starting at least from the pre-chamber and up to at least the first chamber, and wherein the at least one pressure compensation groove is structured in each case as a tapering of the at least one guide groove into the at least one inner surface of the housing.

14. The housing according to claim 11, wherein the housing is a brake master cylinder housing or a housing of a motorized brake pressure buildup device which can be or is integrated into a hydraulic system of the vehicle brake system.

15. A piston-cylinder device for a vehicle brake system, comprising:
a pre-chamber formed on and/or in the piston-cylinder device;
a first chamber formed in the piston-cylinder device;
a first piston component which is arranged adjustably on and/or in the piston-cylinder device in such a way that the first chamber is located on a first side of the first piston component, the pre-chamber is located on a second side of the first piston component directed away from the first side, and a volume of the first chamber can be reduced by an adjusting movement of the first piston component, the adjusting movement being oriented in a direction away from the pre-chamber toward the first chamber; and
at least one second piston component, which is arranged adjustably in the piston-cylinder device in such a way that at least one force initiating the adjusting movement oriented in the direction away from the pre-chamber toward the first chamber can be transmitted to the second piston component via a mechanical contact of the first piston component with the second piston component or a mechanical contact between the first piston component, of at least one compact force-transmission component arranged between the first piston component and the second piston component, and the second piston component;
wherein at least one pressure compensation path is formed on and/or in the piston-cylinder device in such a way that, during the adjusting movement of the first piston component, the adjusting movement being oriented in the direction away from the pre-chamber toward the first chamber, at least one gaseous and/or liquid medium present in the first chamber can be transferred out of the first chamber through the at least one pressure compensation path into the pre-chamber.

16. The piston-cylinder device according to claim 15, wherein the piston-cylinder device is a brake master cylinder or a motorized brake pressure buildup device that can be or is integrated into a hydraulic system of the vehicle brake system.

17. A production method for a housing for a piston-cylinder device of a vehicle brake system, the production method comprising the following steps:
forming a pre-chamber on and/or in the housing;
forming a first chamber in the housing, wherein the pre-chamber and the first chamber are arranged relative to one another in such a way that a first piston component can be adjustably arranged on and/or in the housing in such a way that the first chamber is located on a first side of the first piston component, the pre-chamber is located on a second side of the first piston component directed away from the first side, and a volume of the first chamber can be reduced by an adjusting movement of the first piston component, the adjusting movement being oriented in a direction away from the pre-chamber toward the first chamber, and wherein at least one second piston component can be adjustably arranged in the housing in such a way that at least one force initiating the adjusting movement oriented in the direction away from the pre-chamber toward the first chamber can be transmitted to the second piston component via a mechanical contact of the first piston component with the second piston component or a mechanical contact between the first piston component, of at least one compact force transmission component arranged between the first piston component and the second piston component, and the second piston component; and
structuring at least one pressure compensation groove, which extends in each case starting at least from the pre-chamber and up to at least the first chamber, into at least one inner surface of the housing, in such a way that, during the adjusting movement of the first piston component, the adjusting movement being oriented in the direction away from the pre-chamber toward the first chamber, at least one gaseous and/or liquid medium present in the first chamber can be transferred out of the first chamber through the at least one pressure compensation groove into the pre-chamber.

18. The production method according to claim 17, wherein the at least one pressure compensation groove is structured using an extrusion process into the at least one inner surface of the housing.

19. The production method according to claim 17, wherein for at least one guide part of the first piston component, at least one guide groove, which extends in each case starting at least from the pre-chamber and up to at least the first chamber, is structured into the at least one inner surface of the housing in such a way that, after the first piston component has been arranged, the at least one guide part of the first piston component projects in each case into the at least one guide groove, and wherein the at least one pressure compensation groove is structured in each case as a tapering of the at least one guide groove into the at least one inner surface of the housing.

20. A production method for a piston-cylinder device for a vehicle brake system, the producting method comprising the following steps:
forming a pre-chamber on and/or in the piston-cylinder device;
forming a first chamber in the piston-cylinder device;
arranging a first piston component to be adjustable in such a way on and/or in the piston-cylinder device that the first chamber is located on a first side of the first piston component, the pre-chamber is located on a second side of the first piston component directed away from the first side, and a volume of the first chamber is reduced by an adjusting movement of the first piston component, the adjusting movement being oriented in a direction away from the pre-chamber toward the first chamber;
arranging at least one second piston component to be adjustable in the piston-cylinder device in such a way that at least one force initiating the adjusting movement oriented in the direction away from the pre-chamber toward the first chamber is transmitted to the second piston component via a mechanical contact of the first piston component with the second piston component or a mechanical contact between the first piston component, of at least one compact force transmission component arranged between the first piston component and the second piston component, and the second piston component;
forming at least one pressure compensation path on and/or in the piston-cylinder device in such a way that, during the adjusting movement of the first piston component, the adjusting movement being oriented in the direction away from the pre-chamber toward the first chamber, at least one gaseous and/or liquid medium present in the first chamber is transferred out of the first chamber through the at least one pressure compensation path into the pre-chamber.
